(19) United States
(12) Patent Application Publication
(10) Pub. No.: US 2007/0164544 A1
(43) Pub. Date: Jul. 19, 2007

(54) Bracket for air bag

(75) Inventors: Brian Fulmer, Hooper, UT (US); Linford Smith, Liberty, UT (US)

Correspondence Address: Sally J. Brown;Autoliv ASP, Inc., 3350 Airport Road, Ogden, UT, 84405, US

(73) Assignee: AUTOLIV INC.

(21) Appl. No.: 11/337,130

(22) Filed: Jan. 19, 2006

(51) Int. Cl. B60R 21/213; B60R 21/16

(52) U.S. Cl. 280/730.2; 280/728.2

(57) ABSTRACT

A bracket suitable for guiding the direction of deployment of an inflatable element in a vehicle is provided. The bracket includes a first surface and a second surface. The second surface includes a plurality of spaced slits. The plurality of spaced slits enables the bracket to undergo at least one physical change when impacted.

### BACKGROUND

The present invention generally relates to a guiding device for use in a vehicle. Specifically, the present invention relates to a bracket for use with an air bag.

Air bags, such as side air bags, are provided in vehicles to protect passengers in case of a rollover or a side impact. Side air bags inflate after a predetermined load is applied to the side or flank of a vehicle. Side air bags usually inflate over the pillars and windows of the vehicle. Certain air bags may also inflate along the roof of the vehicle.

In order to guide and position the deployment of the side air bag, brackets are used such as jump brackets and reaction brackets. However, such brackets should be able to sustain the high forces that are applied when the side air bag is deployed. Further, the brackets should enable the deployment in such a manner so as to minimize the time it takes for the side air bag to be in position.

It may be noted that in certain cases, side air bags do not deploy during minor accidents or technical faults. In such cases when the side air bag fails to deploy, the passenger may impact the bracket and sustain a head injury. Therefore, a bracket should be designed so as to reduce the impact. Additionally, the bracket should prevent the side air bag from reacting against any object that is not suitable for its functioning.

### SUMMARY

A first object of the present invention is to provide a bracket that stiffens when impacted on a first surface.

A second object of the present invention is to provide a bracket that yields when impacted on a second surface.

A third object of the present invention is to provide a bracket that decreases the time taken by an inflatable element to be in position for passenger protection.

A fourth object of the present invention is to provide a bracket that prevents the inflatable element from reacting against any object that is not suitable for its functioning.

The above said objectives are achieved by providing a bracket suitable for guiding the direction of deployment of an inflatable element in a vehicle. The bracket includes a first surface and a second surface. The second surface further includes a plurality of spaced slits which enable the bracket to yield when impacted on the second surface. Besides, the plurality of slits enables the bracket to stiffen when impacted on the first surface. Additionally, the bracket includes a retaining portion for retaining the inflatable element in a predefined position.

### BRIEF DESCRIPTION OF THE FIGURES

Various embodiments of the invention will hereinafter be described in conjunction with the appended drawings provided to illustrate and not to limit the invention, wherein like designations denote like elements, and in which:

FIG. 1 shows an environment where various embodiments of the present invention can be implemented.

FIG. 2 illustrates an air bag arrangement suitable for use in a vehicle, in accordance with various embodiments of the present invention.

FIG. 3a is an isometric view of a reaction bracket, in accordance with an embodiment of the invention.

FIG. 3b is an isometric view of the reaction bracket, in accordance with alternative embodiment of the present invention

FIG. 4a is a side view of the reaction bracket illustrating a deflected position, in accordance with various embodiments of the present invention.

FIG. 4b is a side view of the reaction bracket showing the difference between an original position of the reaction bracket and the deflected position, in accordance with various embodiments of the invention.

FIG. 5 is an isometric view of the reaction bracket shown in FIG. 2 in the original position, in accordance with various embodiments the invention.

FIG. 6a is a side view of the reaction bracket shown in FIG. 5 in the original position, in accordance with an embodiment of the invention.

FIG. 6b is a side view of the reaction bracket shown in FIG. 5, in accordance with an alternative embodiment of the invention.

FIG. 7a illustrates a slit when the reaction bracket shown in FIG. 5 is in the original position.

FIG. 7b illustrates the slit when the reaction bracket shown in FIG. 5 is impacted on a first surface.

FIG. 7c illustrates the slit in accordance with the embodiment of the reaction bracket shown in FIG. 6b.

FIG. 8 illustrates an air bag arrangement suitable for use in the vehicle, in accordance with an alternative embodiment of the present invention.

FIG. 9a is an isometric front view of a jump bracket, in accordance with the embodiment shown in FIG. 8.

FIG. 9b is an isometric back view of the jump bracket, in accordance with various embodiments of the invention.

FIG. 10 is a back view of the jump bracket, in accordance with various embodiments of the invention.

FIG. 11a is a side view of the jump bracket illustrating a yielded position, in accordance with various embodiments of the present invention.

FIG. 11b is a side view of the jump bracket showing the difference between an original position and the yielded position of the jump bracket in accordance with various embodiments of the invention.

### DESCRIPTION OF PREFERRED EMBODIMENTS

The invention relates to a bracket for use in a vehicle. Specifically, the invention relates to a bracket suitable for use with an inflatable element such as a side air bag. The bracket is used for guiding the direction of deployment of the inflatable element when activated. The bracket includes slits on a surface which enable the bracket to undergo either yielding or stiffening when impacted.

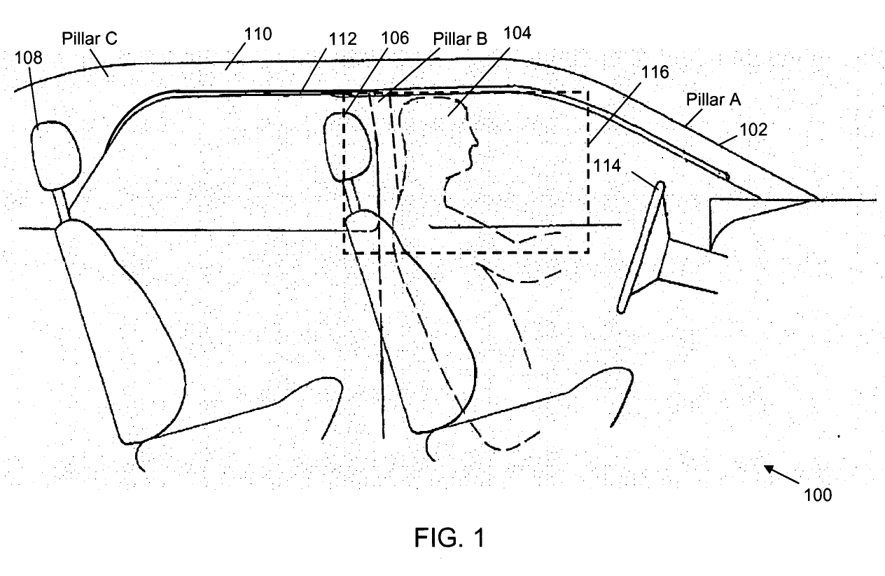

FIG. 1 shows an environment 100 where various embodiments of the present invention can be implemented. Environment 100 includes a cross section of vehicle 102, a passenger 104, a front seat 106, a rear seat 108, a roof 110, a roof rail 112, a steering wheel 114 and a deployment zone 116. In an embodiment, passenger 104 is seated in front seat 106 located behind steering wheel 118.

At least one air bag arrangement, including an inflatable element, (such as, for example a side air bag) and a bracket, may be attached to roof 110. Examples of the bracket include, but are not limited to, a reaction bracket, a jump bracket and the like. In case of a side impact or a roll over, the side air bag may be activated and deployed into deployment zone 116.

Deployment zone 116 may include the region between and including the pillars of vehicle 102, such as pillar A and pillar B. In various other embodiments, deployment zone 116 may also include the region between pillar B and pillar C. Alternatively, deployment zone 116 may include the entire region between pillar A and pillar C.

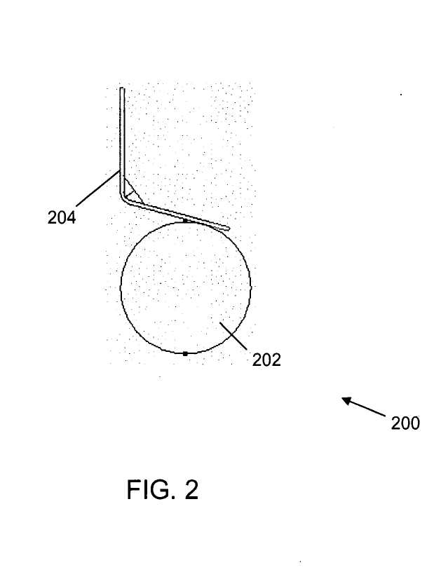

FIG. 2 illustrates an air bag arrangement 200 suitable for use in vehicle 102, in accordance with various embodiments of the present invention. Air bag arrangement 200 includes an inflatable element 202 and a reaction bracket 204. Examples of inflatable element 202, include but are not limited to, a curtain air bag, a tubular air bag and the like. In an embodiment, air bag arrangement 200 is attached to roof rail 112 of vehicle 102. The method of attachment of air bag arrangement 200 may also include attaching inflatable element 202 to roof 110.

Inflatable element 202, shown in a rolled position, is deployed in the event of a side impact or a roll-over. An exemplary sensing system for deploying inflatable element 202 is described herein: a sensor, placed in vehicle 102, senses a side impact or a roll-over situation and activates a gas generator. This activation takes place if the side impact exceeds a predetermined value. Thereafter, the gas generator inflates inflatable element 202, which is deployed in deployment zone 116. In various embodiments, inflatable element 202 may take between one tenth and one twentieth of a second to deploy completely. Further, reaction bracket 204 guides the direction of the deployment of inflatable element 202 along a side window of vehicle 102 to prevent passenger 104 from impacting the window or any other part of vehicle 102.

It may be noted that in case of a minor side impact or a failure of the sensor, inflatable element 202 may not be deployed. In this case, passenger 104 may impact reaction bracket 204, causing reaction bracket 204 to suffer a head impact load. In various embodiments, the head impact load is the load applied by passenger 104 on a bracket placed in vehicle 102.

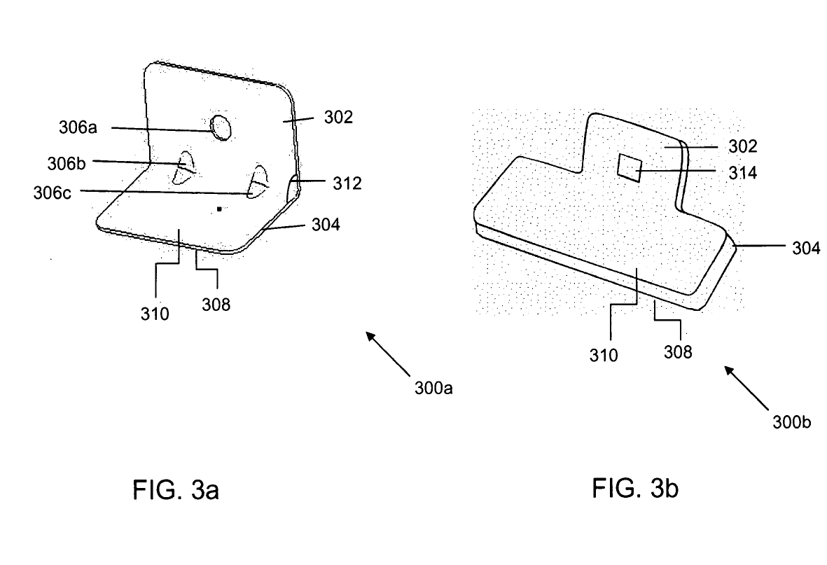

FIG. 3a is an isometric view of reaction bracket 204, in accordance with an embodiment of the invention. Reaction bracket 300a includes an attachment portion such as an upper attachment portion 302, a retaining portion such as a lower retaining portion 304, and a plurality of holes 306, including a first hole 306a, a second hole 306b and a third hole 306c. Lower retaining portion 304 includes a first surface 308 and a second surface 310. Further inflatable element 202 may be held in a predefined position by lower retaining portion 304. The predefined position may be, for example, a folded or a rolled position in which the inflatable element 202 is attached to reaction bracket 204. In an embodiment, the width of upper attachment portion 302 is equal to that of lower retaining portion 304.

Upper attachment portion 302 is at an angle 312 to lower retaining portion 304. In an embodiment, angle 312 may be decided depending on the direction of deployment of inflatable element 202. Angle 312 may also be decided based on the intensity of inflation of inflatable element 202. For instance, if inflatable element 202 inflates to a large extent, angle 312 may be kept relatively small in order to guide the deployment in a direction closer to a window of vehicle 102. Angle 312 may be, for example, between 90 degrees and 180 degrees.

In various embodiments, plurality of holes 306 is used for attaching reaction bracket 204 to roof rail 112. Reaction bracket 204 may be attached to roof rail 110 via a screw and thread arrangement. Alternatively a clip may be used for attaching reaction bracket to roof rail 112. Other means of attachment include bolts or rivets connected through plurality of holes 306, thereby providing a rigid and secure connection between reaction bracket 204 and roof rail 112.

It may be apparent to a person skilled in the art that more than one reaction brackets may be attached to roof rail 112. The number of reaction brackets may be dependent on the number of points at which inflatable element 202 is attached to roof 110. Another exemplary factor that influences the number of brackets attached to roof rail 112 is the width of reaction bracket 204. The larger the width of reaction bracket 204, the lesser the number of reaction brackets that would be needed for correctly deploying inflatable element 202,

FIG. 3b is an isometric view of reaction bracket 204, in accordance with alternative embodiment of the present invention. A reaction bracket 300b includes upper attachment portion 302, lower retaining portion 304 and a hole 314. As described with reference to FIG. 3a, lower retaining portion 304 includes first surface 308 and second surface 310. In accordance with the embodiment, the width of upper attachment portion 302 is less than the width of lower retaining portion 304. Reaction bracket 300b may be attached to roof rail 112 of the vehicle using hole 314 by the attachment means described with reference to FIG. 3a.

In both the embodiments of reaction bracket 300a and 300b described above, inflatable element 202 may be held in a folded position by lower retaining portion 304. During deployment, inflatable element 202 reacts against first surface 308, thereby enabling its deployment in a direction guided by angle 312. For instance, if angle 312 were to be increased to 100 degrees, as compared to 90 degrees, inflatable element 202 would be deployed closer to a window of vehicle 102. Further, first surface 308 provides a rigid support for inflatable element 202 to react against during deployment. First surface 308 also prevents inflatable element 202 from pushing into the space behind the headliner of vehicle 102 during deployment. In various embodiments, the headliner is a fabric covering the interior of roof 110 and may be made of lightweight fabric.

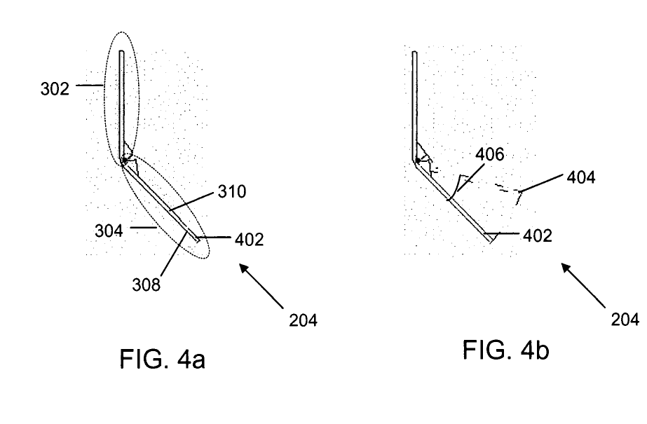

As explained with reference to FIG. 2, in the case of a side impact or a roll-over where inflatable element 202 is not deployed passenger 104 imparts a head impact load on reaction bracket 204. In various embodiments, the head impact load may deflect lower retaining portion 304. The deflection of lower retaining portion 304 is explained in detail with reference to FIG. 4a and FIG. 4b.

FIG. 4a is a side view of reaction bracket 204 illustrating a deflected position 402, in accordance with various embodiments of the present invention. The deflection of reaction bracket 204 enables better absorption of an applied force, such as the head impact load, on second surface 310. FIG. 4b is a side view of reaction bracket 204 showing the difference between an original position 404 of reaction bracket 204 and deflected position 402, in accordance with various embodiments of the invention. Lower retaining portion 304 deflects through an angle 406 from original position 404 to deflected position 402. Angle 406 may be, for example, between zero degrees and 90 degrees depending on the intensity of the head impact load that passenger 104 applies on second surface 310.

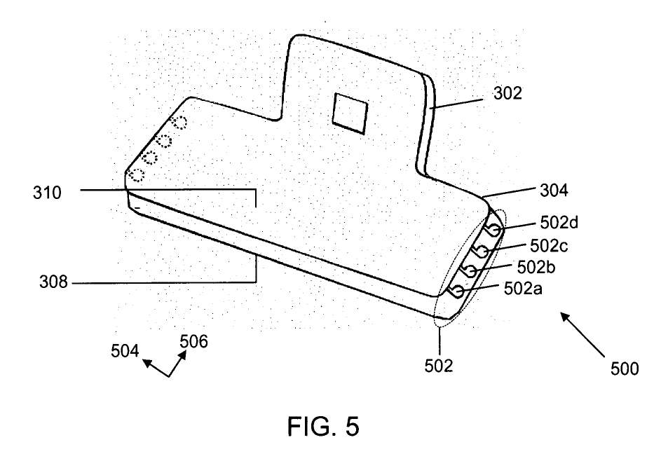

FIG. 5 is an isometric view of reaction bracket 204, in accordance with various embodiments the invention. Reaction bracket 500 includes upper attachment portion 302, lower retaining portion 304, first surface 308 and second surface 310. Lower retaining portion 304 includes a plurality of spaced slits 502, including a slit 502a, a slit 502b, a slit 502c and a slit 502d. Plurality of spaced slits 502 extend throughout the length (along direction 504) of lower retaining portion 304. In an embodiment, the distance between each slit in plurality of spaced slits 502 may be, for example, between two millimeters and five millimeters depending on the width (along direction 506) of lower retaining portion 304. In various embodiments, plurality of spaced slits 502 are provided to enable reaction bracket 500 to undergo a physical change when impacted. For example, reaction bracket 500 stiffens when impacted on first surface 308 and yields when impacted on second surface 310. Further, plurality of spaced slits 502 may be placed on an inboard side of reaction bracket 500, wherein the inboard side is the side that suffers the direction of the head impact load.

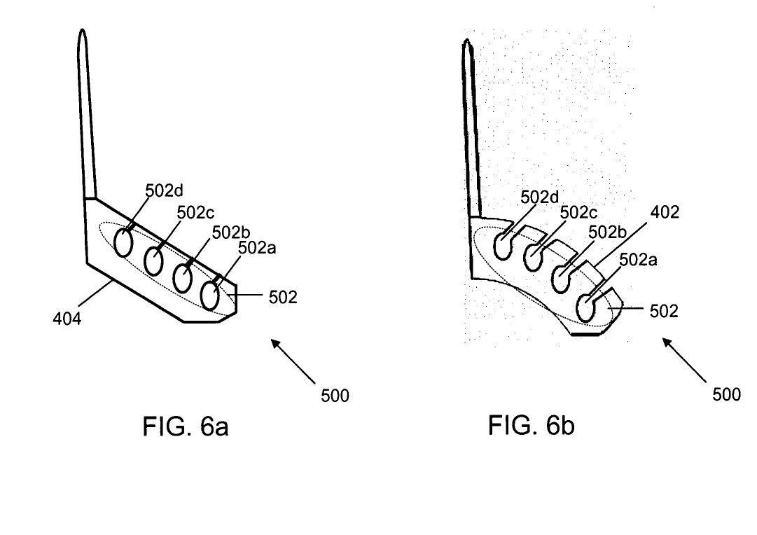

FIG. 6a is a side view of reaction bracket 500 in original position 404, in accordance with various embodiments of the invention. Each slit of plurality of spaced slits 502 includes two opposing surfaces. In various embodiments of the invention, there is a small distance (not shown) between the two opposing surfaces in each of plurality of spaced slits 502. The small distance may be, for example, in the order of microns. In another embodiment, the two opposing surfaces may be in contact with each other without the application of any force.

It is noted that in order to further reduce head impact load when passenger 104 impacts reaction bracket 204, lower retaining portion 304 yields after deflecting from original position 404. This yielding is explained in detail with reference to FIG. 6b.

FIG. 6b is a side view of reaction bracket 500, in accordance with an alternative embodiment of the invention. To enable yielding of lower retaining portion 304, each slit of plurality of spaced slits 502 opens up, i.e. the two opposing surfaces in each slit of plurality of spaced slits 502 move apart from each other.

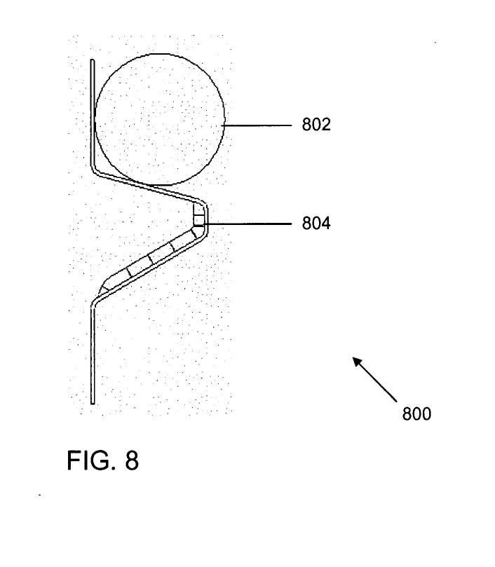

FIG. 7a illustrates a slit 502a when reaction bracket 500 is in original position 404. Slit 502a includes a groove 702, a first face 704 and a second face 706. In accordance with an embodiment of the invention, first face 704 is parallel to second face 706.

FIG. 7b illustrates slit 502a, when reaction bracket 500 is impacted on first surface 308. First face 704 mates or comes in contact with second face 706, when the deployment load of the inflatable element 202 is applied on first surface 308. In various embodiments, a similar mating of first face 704 with second face 706 for each slit of plurality of spaced slits 502 enables reaction bracket 204 to stiffen and thereby reinforce.

FIG. 7c illustrates slit 502a, in accordance with the embodiment of reaction bracket 500 shown in FIG. 6b. First face 704 moves apart from second face 706 enabling slit 502a to open up. A similar opening up of each slit of plurality of spaced slits 502 enables yielding of reaction bracket 204. In various embodiments, the distance by which first face 704 moves apart from second face 706 increases to at least two or three times in comparison to the distance that exists between first face 704 and second face 706 when reaction bracket 500 is in original position 404. The increase in distance may depend on factors such as, for example, the intensity of the load that passenger 104 applies on second surface 310 and the flexibility offered by the material of reaction bracket 502. In various embodiments, reaction bracket 204 may be made from materials including hot rolled steel, hardened aluminium and the like. Certain grades of plastic such as glass reinforced plastics (made from polymeric resins) having high strength and stiffness may also be used.

FIG. 8 illustrates an air bag arrangement 800 suitable for use in vehicle 102, in accordance with an alternative embodiment of the present invention. Air bag arrangement 800 includes an inflatable element 802 and a jump bracket 804. Jump bracket 804 is used to enable inflatable element 802 to be deployed in a direction to pass an obstruction in the interior of the vehicle 102 (e.g. upper edge of a B-pillar trim). The deployment of inflatable element 802 is carried out as explained with reference to inflatable element 202 shown in FIG. 2. In an embodiment, air bag arrangement 800 is attached to roof rail 112 of vehicle 102. The method of attachment of air bag arrangement 800 may also include attaching inflatable element 802 to roof 110.

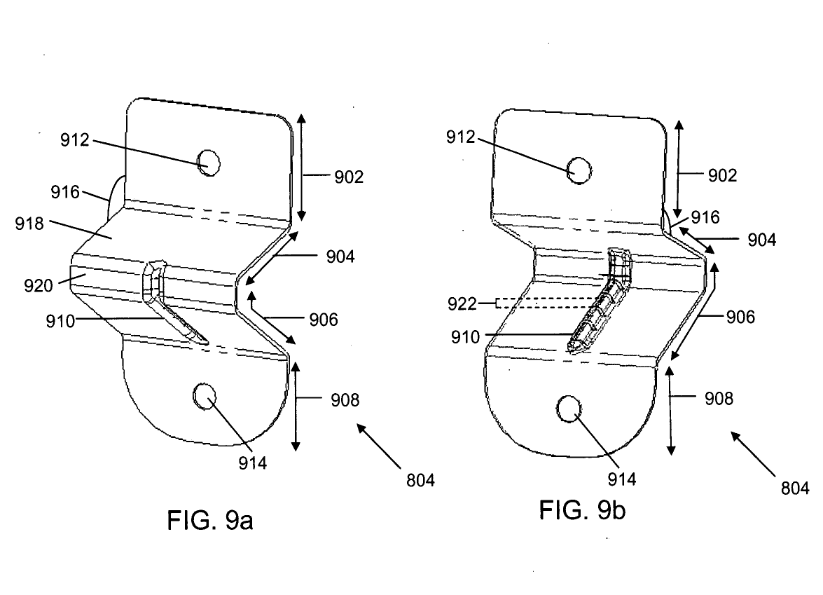

As described with reference to inflatable element 202 shown in FIG. 2, inflatable element 802 may not be deployed in the event of a minor side impact or a failure of the sensor. In an event wherein passenger 104 impacts jump bracket 804, jump bracket 804 may undergo deflection. Further, jump bracket 804 may also yield as it undergoes deflection. The reaction of jump bracket 804 is described in detail with reference to FIG.9 to FIG. 11.

FIG. 9a is an isometric front view of jump bracket 804, in accordance with various embodiments of the present invention. Jump bracket 804 includes an upper attachment portion 902, a first surface 904, a second surface 906 and a lower attachment portion 908. Second surface 906 includes a protrusion portion 910. First surface 904 includes an area 918 which may be used to retain inflatable element 802 in a predefined position. The predefined position may be, for example, a folded position or a rolled position. Further, first surface 904 provides a rigid support for inflatable element 802 to react against during deployment. First surface 904 also prevents inflatable element 802 from pushing into the space behind the pillar trim of vehicle 102 during deployment. Second surface 906 includes an area 920, wherein the head impact load of passenger 104 could be applied. First surface 904 and second surface 906 form an A-shaped structure as is shown.

Further, upper attachment portion 902 includes upper hole 912, while lower attachment portion 908 includes lower hole 914. Jump bracket 804 is attached to roof rail 112 of the vehicle by means of upper hole 912 and lower hole 914 by methods known in the art. The methods may include a screw and thread arrangement, a clip and hole arrangement, and the like. Other means of attachment include bolts or rivets connected through upper hole 912 and lower hole 914.

It may be apparent to a person skilled in the art that the more than one jump brackets may be attached to roof rail 112. As described with reference to reaction bracket 300a shown in FIG. 3a, the number of jump brackets may be dependent on the number of points at which inflatable element 802 is attached to roof 110 and the width of jump bracket 804.

Additionally an angle 916 exists between upper attachment portion 902 and first surface 904. In various embodiments, angle 916 may be between, for example, 90 degrees and 160 degrees. Further, angle 916 influences the direction in which inflatable element 802 is deployed.

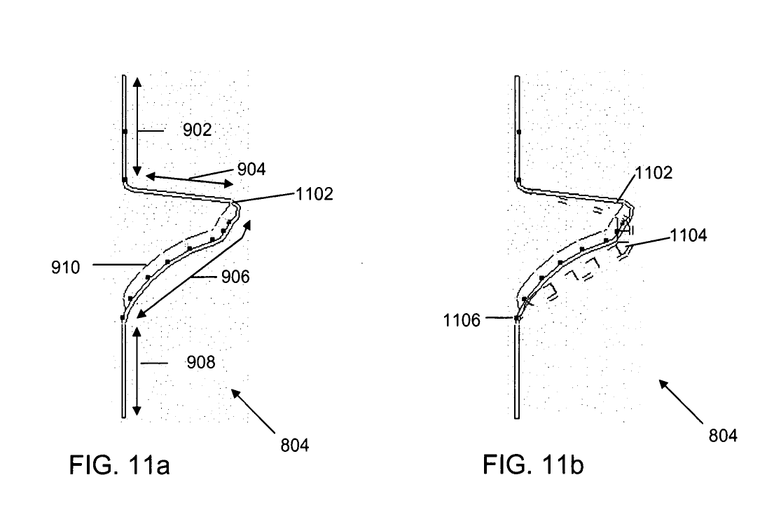

FIG. 9b is an isometric back view of jump bracket 804, in accordance with various embodiments of the invention. Protrusion portion 910, which in various embodiments is placed at the centre of second surface 906, includes a cylindrical upper surface that includes a plurality of slits. The plurality of slits enables jump bracket 804 to undergo a physical change when impacted. For example, jump bracket 804 yields when a head impact load is applied on area 920 or 906. In another embodiment, the plurality of slits enable the jump bracket 804 to stiffen when impacted on area 918. Further, a height 922 of protrusion portion 910 may be between two millimetres and ten millimetres. Protrusion portion 910 is explained in detail with reference to FIG. 11a and FIG. 11b.

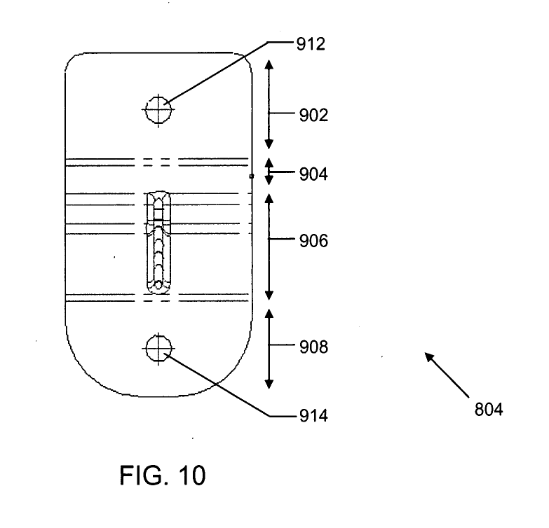

FIG. 10 is a back view of jump bracket 804, in accordance with various embodiments of the invention.

In case of a side impact or a roll-over where inflatable element 802 is not deployed, passenger 104 may impact jump bracket 804, thereby applying a head impact load on second surface 906. In such a case, first surface 904 and second surface 906 yields to reduce the intensity of the head impact load that occurs and allows for a reduction in the reaction force offered by jump bracket 804.

FIG. 11a is a side view of jump bracket 804 illustrating a yielded position 1102, in accordance with various embodiments of the present invention. FIG. 11b is a side view of jump bracket 804 showing the difference between an original position 1104 of bracket 804 and yielded position 1102, in accordance with various embodiments of the invention.

For the purpose of the explanation of the yielding of protrusion portion 910, a representative case of a slit 1106 in protrusion portion 910 is explained herein.

Each slit in protrusion portion 910 includes two opposing faces (not shown) similar to each slit in plurality of slits 502. The opposing faces in slit 1106 move apart to open up. A similar opening up of each slit in protrusion portion 910 enables yielding of jump bracket 804. The distance by which the opposing faces move apart may be dependent on factors such as the material of jump bracket 804, the intensity of head impact and the like.

Moreover, in case of an impact on area 918, caused due to deployment of inflatable element 802, the opposing faces in slit 1106 in protrusion portion 910 mate or in come in contact with each other. In various embodiments, a similar mating of the opposing surfaces of each slit in protrusion portion 910 enables jump bracket 910 to stiffen and thereby reinforce.

Various embodiments of the invention provide a bracket for use in a vehicle that stiffens in the direction an inflatable element applies force while being deployed. The bracket includes slits whose opposing faces mate or come in contact with each other when the force is applied.

Various embodiments of the invention provide a bracket that yields or decreases stiffness in the direction of head impact. The opposing surfaces in each slit move apart when a passenger impacts the bracket, thereby enabling the bracket to yield.

Various embodiments of the invention provide a bracket that prevents an inflatable element from reacting against objects that are not suitable for its functioning. This is enabled by deploying the inflatable element in the direction governed by an angle between an attachment portion and a surface of the bracket.

Various embodiments of the invention provide a bracket that decreases the time taken by the inflatable element to be in place for passenger protection. The bracket guides the inflatable element in a specific direction during deployment, thereby decreasing the time taken by an inflatable element to be in place for head protection.

Various embodiments of the invention also provide a bracket which is attached to a roof rail of the vehicle using a minimum number of fixed points. In accordance with various embodiments, the reaction bracket may include between one and three holes that are used for attachment to the roof rail.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. An air bag arrangement suitable for use in a vehicle, the air bag system comprising:
an inflatable element; and
a bracket for regulating direction of expansion of the inflatable element, the bracket comprising a plurality of spaced slits for enabling the bracket to undergo at least one physical change when impacted.

2. The air bag arrangement according to claim 1, wherein the bracket comprises:
a first surface; and
a second surface, the second surface comprising the plurality of spaced slits.

3. The air bag arrangement according to claim 1, wherein the physical change of the bracket comprises yielding.

4. The air bag arrangement according to claim 1, wherein the physical change of the bracket comprises stiffening.

5. The air bag arrangement according to claim 1, wherein the bracket stiffens when impacted on the first surface.

6. The air bag arrangement according to claim 1, wherein the bracket yields when impacted on the second surface.

7. The air bag arrangement according to claim 1, wherein the bracket is mounted on a roof rail of the vehicle.

8. The air bag arrangement according to claim 1, wherein the bracket is a reaction bracket

9. The air bag arrangement according to claim 1, wherein the bracket is a jump bracket.

10. The air bag arrangement according to claim 1, wherein the bracket provides a defined direction for deployment of the inflatable element.

11. The air bag arrangement according to claim 1, wherein the bracket comprises a retaining portion for retaining the inflatable element in a predefined position.

12. The air bag arrangement according to claim 11, wherein the retaining portion comprises the plurality of spaced slits which extend throughout the whole length of retaining portion.
